(19) United States
(12) Patent Application Publication
(10) Pub. No.: US 2014/0158869 A1
(43) Pub. Date: Jun. 12, 2014

(54) Detachable Viewing Apparatuses and Methods of Making and Using the Same

(71) Applicant: Guillermo Jorge Keller, Santa Clarita, CA (US)

(72) Inventor: Guillermo Jorge Keller, Santa Clarita, CA (US)

(21) Appl. No.: 13/836,121

(22) Filed: Mar. 15, 2013

Related U.S. Application Data
(60) Provisional application No. 61/736,457, filed on Dec. 12, 2012.

(51) Int. Cl. G02B 27/02; G01J 1/04

(52) U.S. Cl. CPC G02B 27/028; G01J 1/0466
USPC 250/216; 359/643; 29/428

(57) ABSTRACT

Removable and/or detachable viewing devices for optical and/or other measuring equipment and methods of making and using the same are disclosed. The viewing device includes a housing, an eyepiece, and an attachment mechanism configured to releasably or detachably connect the viewing device to an optical measuring instrument. An optical measuring system includes an optical measuring instrument and the viewing device detachably connectable to the optical measuring instrument. The optical measuring kit may include one or more caps or plugs detachably connectable to the opening of the optical measuring instrument and/or the interface end of the viewing device.

### RELATED APPLICATIONS

This application claims the benefit of U.S. Provisional Patent Application No. 61/736,457, filed Dec. 12, 2012 (Attorney Docket No. CRI-001-PR), which is incorporated herein by reference in its entirety.

### FIELD OF THE INVENTION

The present invention generally relates to the field of viewing systems. More specifically, embodiments of the present invention pertain to detachable viewing systems for optical and/or other measuring equipment, and methods of making and using the same.

### DISCUSSION OF THE BACKGROUND

Optical measuring instruments are commonly used in scientific research, quality control or production measurement. Examples of optical measuring instruments include photometers, colorimeters and spectroradiometers. Optical measuring instruments can be used for color matching, colorimetry, spectrophotometry, and quality control (e.g., during the manufacture of CRT, LCD and LED displays), etc.

Optical measuring instruments may incorporate a fixed reflex viewing system, where it is important to see exactly the object at which the optical measuring instrument is looking. Reflex viewing systems have a single optical path that allows the user to have the same optical view as the instrument. Further, in such a viewing system, the image is erect, and not reversed as in a “mirror image.” For example, a single lens reflex camera generally comprises a mirror and a prism, and allows the viewer to see the object directly through the lens, and thereby view the image that will be captured by the camera. Frequently in research and online production measurement setups, it is not possible for the observer to be directly behind the apparatus, as in the single lens reflex viewing system example.

A Pritchard optical system (see, e.g., U.S. Pat. Nos. 3,813,172 and 3,799,680) may be used in conventional optical measuring instruments such as a colorimeter. Light and/or an image pass through an objective lens of the measuring instrument and strike a mirror with an aperture formed therein. In a conventional Pritchard optical system, a portion of the light and/or image being processed and/or measured passes through the aperture of the mirror and is further processed and/or measured by the measuring instrument. Another portion of the light and/or image that reflects from the mirror passes into the viewing portion of the measuring instrument (e.g., an eyepiece).

The Pritchard optical system has been utilized for several decades and is typically used in optical measuring instruments. However, the eyepiece is in a fixed location on the instrument, and is otherwise non-detachable and non-movable. The viewing systems of conventional optical measuring instruments are generally permanently attached to the measuring instrument. In situations where a user has multiple optical measuring instruments, the user will have multiple viewing systems. This means that a user having tens or hundreds of optical measuring instruments will have spent additional money on redundant viewing systems attached to those optical measuring instruments. Further, a relatively small number of persons use the instruments at any given time, resulting in infrequent use of the multiple, redundant viewing systems. Those persons who use the instrument(s) may do so constantly or frequently, resulting in inefficient use of the multiple, redundant viewing systems.

This “Background” section is provided for background information only. The statements in this “Background” are not an admission that the subject matter disclosed in this “Background” section constitutes prior art to the present disclosure, and no part of this “Background” section may be used as an admission that any part of this application, including this “Background” section, constitutes prior art to the present disclosure.

### SUMMARY OF INVENTION

Embodiments of the present invention advantageously provide a removable and/or detachable viewing device for measuring instruments, such as optical measuring instruments (e.g., photometers, colorimeters, spectroradiometers, etc.). In one aspect, the present invention provides a detachable viewing device, comprising a housing, having an interface end opposite a viewing end; an eyepiece, having one or more lenses, and located at or near the viewing end; and an attachment mechanism configured to releasably or detachably connect the viewing device to an optical measuring instrument. In some embodiments, the detachable viewing device further comprises one or more rotatable joints or connections allowing at least part of the viewing device to be rotated (e.g., horizontally and/or vertically).

In a second aspect, the present invention concerns an optical measuring system comprising an optical measuring instrument and the present viewing device, detachably connected to the optical measuring instrument. The optical measuring instrument may have an opening comprising a ring or collar on the inside, configured to engage with a corresponding groove or notch on the viewing device. Alternatively, the viewing device may comprise the ring or collar on and/or near the interface end of the housing. In a further alternative, the viewing device may have the opening, and the optical measuring instrument may have the interface with an attachment mechanism for detachably and/or reversibly connecting the viewing device.

In a third aspect, the present invention provides an optical measuring kit comprising an optical measuring instrument having an opening, a viewing device having an interface end that is detachably connectable to the opening of the optical measuring instrument, and one or more caps or plugs configured to be removable or detachably connected to the opening of the optical measuring instrument and/or the interface end of the viewing device. The cap(s) may fit over and/or mate with the opening of the optical measuring instrument and/or the interface end of the viewing device. For example, the plug(s) may be insertable into the opening of the optical measuring instrument and/or adapted to closely and/or snugly fit over the interface end of the viewing device. At least one of the caps or plugs may comprise a groove configured to engage with an inner surface of the opening of the optical measuring instrument (e.g., a corresponding ring or collar on the surface of the opening) and/or the interface end of the viewing device.

In another aspect, the present invention provides a method of viewing an object comprising attaching the present detachable viewing device to an optical measuring instrument, observing an object through the viewing device and the optical measuring instrument, and removing the viewing device from the optical measuring instrument.

In a still further aspect, the present invention provides method of making a detachable viewing device comprising forming a housing having an interface end opposite a viewing end, permanently or detachably connecting an eyepiece to the viewing end of the housing, and forming an attachment mechanism at or near the interface end of the housing configured to releasably or detachably connect to an optical measuring instrument.

These and other advantages of the present invention will become readily apparent from the detailed description of various embodiments below.

### BRIEF DESCRIPTION OF THE DRAWINGS

FIG. 1 is a cut-away view of an embodiment of a detachable viewing apparatus according to an embodiment of the present invention.

FIG. 2 is a cut-away view of another embodiment of a detachable viewing apparatus according to another embodiment of the present invention.

FIG. 3 shows an exemplary cap for the detachable viewing system according to an embodiment of the present invention.

FIG. 4 is a cut-away view of a measuring instrument without a viewing system and fitted with the exemplary cap of FIG. 3.

FIG. 5 is a cut-away view of a detachable rotational viewing apparatus according to one embodiment of the present invention.

FIG. 6 is a cut-away view of a detachable rotational viewing apparatus according to an alternative embodiment of the present invention.

FIG. 7 is a cut-away view of a further embodiment of a detachable viewing apparatus equipped with a shutter.

FIG. 8 is a flow chart showing an exemplary method for using a viewing device according to embodiments of the present invention.

FIG. 9 is a flow chart showing an exemplary method of manufacturing a detachable viewing device according to embodiments of the present invention.

### DETAILED DESCRIPTION

Reference will now be made in detail to various embodiments of the invention, examples of which are illustrated in the accompanying drawings. While the invention will be described in conjunction with the following embodiments, it will be understood that the descriptions are not intended to limit the invention to these embodiments. On the contrary, the invention is intended to cover alternatives, modifications and equivalents that may be included within the spirit and scope of the invention. Furthermore, in the following detailed description, numerous specific details are set forth in order to provide a thorough understanding of the present invention. However, it will be readily apparent to one skilled in the art that the present invention may be practiced without these specific details. In other instances, well-known methods, procedures, components, and circuits have not been described in detail so as not to unnecessarily obscure aspects of the present invention.

For the sake of convenience and simplicity, the terms “eyepiece” and “viewfinder” are generally used interchangeably herein, but are generally given their art-recognized meanings. Also, for convenience and simplicity, the terms “measuring instrument” and “optical measuring instrument” may be used interchangeably, but these terms are also generally given their art-recognized meanings. Further, for convenience and simplicity, the terms “optical axis,” “measurement axis,” and “path” may be used interchangeably, but these terms are also generally given their art-recognized meanings. Further, for convenience and simplicity, the terms “detachable,” “removable,” and “insertable” may be used interchangeably, but these terms are also generally given their art-recognized meanings.

The present invention relates to a removable viewing system and methods of making and using the same. The present removable viewing system advantageously provides a cost savings, where one viewing system can be used with multiple optical measuring instruments. Also, the present invention provides for using multiple viewing systems with a single instrument. Further, the present removable viewing system allows the viewer to use a viewing system that may be easier, more comfortable, and/or better suited for use with multiple optical measuring instruments or experiment/test setups than a traditional, fixed viewing system. Further still, removable optics may lessen the mass of the optical measuring instrument when it needs to be moved (e.g., when mounted on a robotics-controlled XYZ table, positioned on a rotating or transportable support, and/or transported at high velocities and/or acceleration rates).

These and other advantages of the present invention will become readily apparent from the detailed description of various embodiments below.

A First Exemplary Detachable Viewing Device

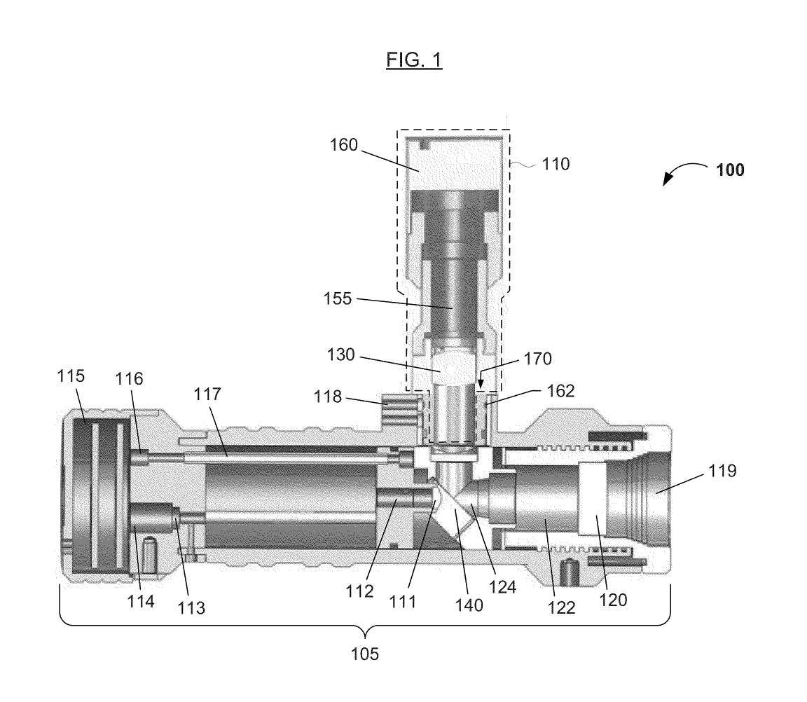

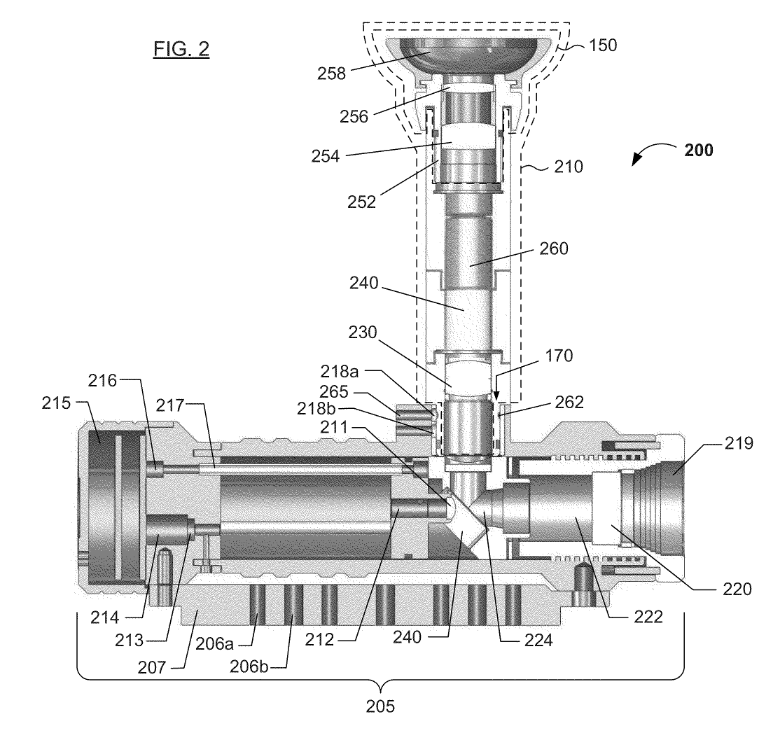

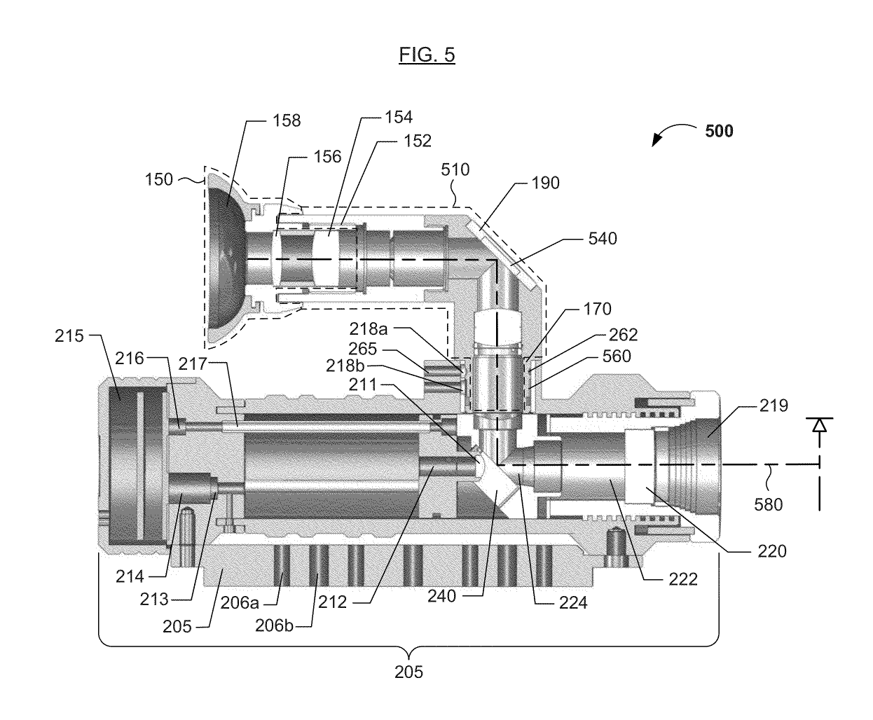

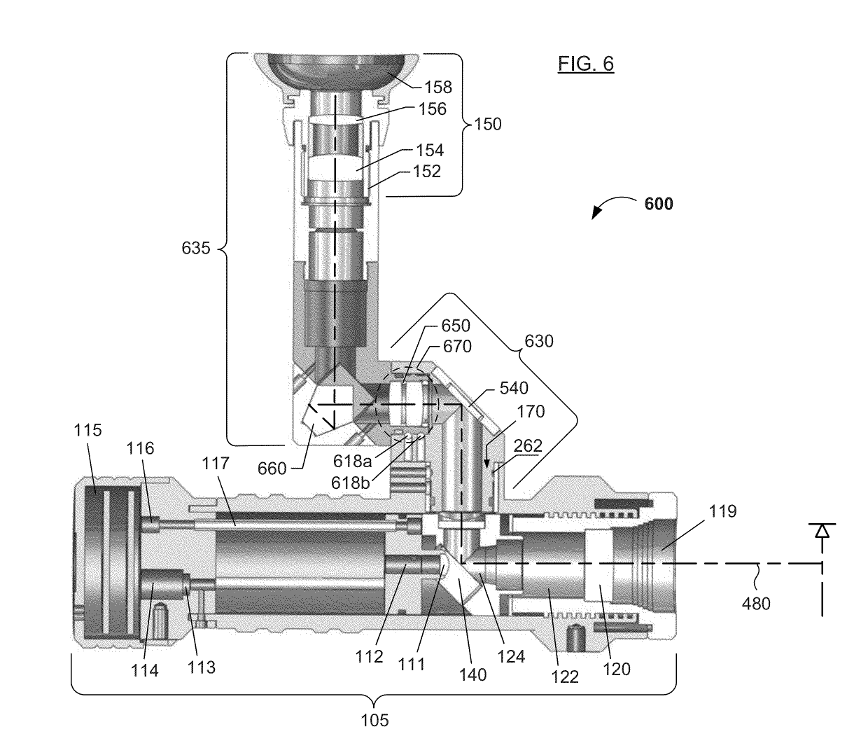

In one aspect, the present invention relates to a viewing device that is detachable from an optical measuring instrument. For example, the present viewing device is easily detachable from the instrument's main body (e.g., it may snap in and out manually), and can be replaced with a different type of viewing device depending on the user's needs. Alternatively, or if not needed, the viewing device can be safely stored while the instrument is free for independent use and/or transportation. FIG. 1 shows one embodiment of a viewing system 100 including a viewing device 110 that is detachably connected to an optical measuring instrument 105 (e.g., at opening 170). A detachable viewing device can be any viewing device capable of viewing light from the object being measured and configured to be removably attached to an optical measuring instrument. For example, viewing device 110 as shown in FIG. 1, viewing device 210 as shown in FIG. 2, viewing device 570 as shown in FIG. 5, and/or viewing device 630-635 as shown in FIG. 6, respectively, may be detachably connected to optical measuring instrument 105.

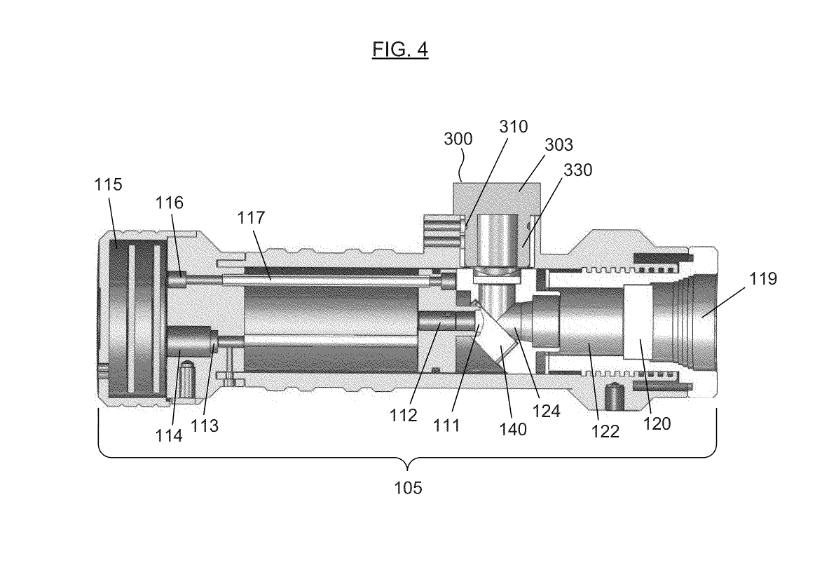

Optical measuring instrument 105 can be any optical measuring instrument that may utilize a viewing system. For example, optical measuring instrument 105 can be any device that measures the photometric, colorimetric and/or spectral characteristics of an object. Optical measuring instrument 105 may contain a focusing and/or objective lens (hereinafter, “focusing lens”) 120 and an angled mirror 140. The angled mirror 140 has at least one aperture or opening. However, angled mirror 140 may have multiple apertures and may also be rotatable (e.g., like a Pritchard optical system). Light from the object being measured or otherwise processed travels through focusing lens 120 and at least one aperture in angled mirror 140 and passes on to the other sections of optical measuring instrument 105. Optical measuring instrument 105 may comprise a coupler lens 111, an optical fiber 112, one or more optical filters 113, one or more photodiodes 114, electronic circuitry 115 configured to process information from the photodiode(s) 114, mounting hardware 116, one or more stand-offs 117, one or more soft stop(s) 118a-b, a lens (e.g., objective lens) 120, a lens hood 119, a hollow 122, and/or an F-stop 124. Optical measuring instrument 105 may also comprise an instrument mounting platform 105. In a further embodiment, instrument mounting platform 105 may have one or more holes (e.g., holes 106a-b) drilled amid/or formed therein for facile mounting of the instrument 110 onto a (movable) surface or platform, for example. Further, angled mirror 140 may have any angle that allows for some light to pass through the aperture to the optical measuring instrument 105 and some light to reflect to the viewing device 110. In a preferred embodiment, the angled mirror 140 has a 45° angle relative to the optical axis 480 (FIG. 4) of the optical measuring instrument 105.

Viewing device 110 has an interface end (e.g., a light receiving end) and a viewing end (e.g., a light output or exit end). Viewing device 110 has a cavity between the interface end and viewing end for holding optics, such as mirrors, lenses, prisms, and/or an eyepiece. Viewing device 110 may have any shape capable of holding the optics and transmitting light from the interface end to the viewing end. In one embodiment, the housing and/or cavity has a substantially cylindrical shape. The overall shape of viewing device 110 can generally be the same as or different from the shape of the cavity. For example, viewing device 110 can be generally cylindrical, rectangular or oval.

The body of viewing device 110 can comprise any material, or combination of materials, capable of housing optics. For example, viewing device 110 may comprise one or more tubes, plates, rings, wires, etc. of metal, plastic, etc., or a combination thereof. In various embodiments, viewing device 110 may comprise an adapter or mount 155 for a camera 160, and one or more lenses 130. The adapter 155 may have a length facilitating or enabling the focal point of the light or image from lens 130 to be at or near the imaging unit (e.g., a charge-coupled device [CCD] or digital [e.g., CMOS] image sensor) and/or lens of the camera 160. Alternatively, an interface for a computer and/or display device can be mounted on or attached to the adapter 155, in place of the camera 160.

Opening 170 can have any shape that allows the optical measuring instrument 105 to receive the viewing device 110 as shown in FIG. 1, viewing device 210 as shown in FIG. 2, viewing device 570 as shown in FIG. 5, and/or viewing device 630-635 as shown in FIG. 6. In one embodiment, the viewing device may have an attachment mechanism on the interface end of the housing. In another embodiment, opening 170 is a cylindrical opening with smooth interior sides wherein a portion of the interface end of the viewing device 110 or 210 has a complimentary or matching shape that is insertable into opening 170. The portion of the viewing device placed into opening 170 may be any length, as long as the viewing system is still capable of allowing the user to view the object being measured by optical measuring instrument 105.

In another embodiment, opening 170 may have a ring or collar 220 on the inside, configured to engage with a corresponding groove or notch on the barrel of the insertable portion of the viewing system. Further, ring or collar 220 may be any configuration for releasably detaching the viewing system (e.g., viewing device 110 as shown in FIG. 1, viewing device 210 as shown in FIG. 2, viewing device 570 as shown in FIG. 5, and/or viewing device 630-635 as shown in FIG. 6). For example, ring or collar 220 may be a continuous ring, a partial ring, and/or one or more protrusions from or on the inside of the opening 170. In a further embodiment, the ring or collar 220 (e.g., an attachment mechanism) may be on the barrel (e.g., at or near the interface end) of the viewing device 200, and the groove or notch may be in the opening 170.

In another embodiment, a gasket may be on the interface end of the viewing device and/or on the inside of the opening of the optical measuring instrument. In one embodiment, the interface end having the gasket is configured to be insertable into the opening, having smooth sides, of the optical measuring instrument. In another embodiment, a viewing device having smooth sides on the interface end can be insertable into the opening of the optical measuring instrument fitted with the gasket. In a further embodiment, the smooth sides of the interface end of the viewing device and/or the opening of the optical measuring instrument can be lubricated and/or coated with a silicone and/or Teflon.

In yet another embodiment, the diameter of the interface end of the viewing device is less than the diameter of the opening of the optical measuring instrument. For example, the difference between the diameter of the interface end of the viewing device and the diameter of the opening of the optical measuring instrument to provide a snug fit for inserting and/or the viewing device into the opening of the optical measuring instrument. In another embodiment, the difference between the dimensions of the interface end of the viewing device and the opening of the optical measuring instrument is expressed as mathematical relationship between the two (e a percentage or absolute number).

Referring back to FIG. 1, a detachable viewing device 110 is shown that includes an adapter 155 and a camera 160. Detachable viewing device 110 is generally straight and perpendicular to optical measuring instrument 105. In various embodiments, viewing device 110 may have one or more lenses and/or groups of lenses (e.g., lens 130) between the interface end and the viewing end of the viewing device 110. Viewing device 110 may further comprise any adapter, mount or fixture capable of mounting, or affixing an instrument adapted to capture, display and/or further process an image of the object being measured, such as a camera, computer, monitor, and/or display (e.g., CRT, LCD, and/or LED display and/or monitor).

A Second Exemplary Detachable Viewing Device

Referring now to FIG. 2, another aspect of the present invention relates to a detachable viewing device 210 that includes an eyepiece 250. Like detachable viewing device 110, detachable viewing device 210 is generally straight and perpendicular to optical measuring instrument 105. Similarly, detachable viewing device 210 can be attached and removed from the optical measuring instrument 205 in substantially the same manner as detachable viewing device 110 can be attached and/or removed from optical measuring instrument 105 (FIG. 1).

Similar to FIG. 1, optical measuring instrument 205 in FIG. 2 can be any optical measuring instrument that utilizes a viewing system. For example, optical measuring instrument 205 can be any device that measures the photometric, colorimetric and/or spectral characteristics of an object. Optical measuring instrument 205 may contain focusing lens 220 and angled mirror 240. Angled mirror 240 has at least one aperture therein. Alternatively, angled mirror 240 may have multiple apertures, and may also be rotatable (e.g., like a Pritchard optical system). Light from the object being measured or otherwise processed travels through focusing lens 220 and at least one aperture in angled mirror 240 and passes on to the other sections of optical measuring instrument 205. Optical measuring instrument 205 may comprise a coupler lens 211, an optical fiber 212, one or more optical filters 213, one or more photodiodes 214, electronic circuitry 215 configured to process information from the photodiode(s) 214, mounting hardware 216, one or more stand-offs 217, a lens (e.g., objective lens) 220, a lens hood 219, a hollow 222, and/or an F-stop 224. Further, angled mirror 240 may have any angle that allows for some light to pass through the aperture to the optical measuring instrument 205 and some light to reflect to the viewing device 210. In one embodiment, the angled mirror 240 has 45° angle with respect to the optical axis 480 (as shown in FIG. 4) of instrument 205. Optical measuring instrument 205 may also comprise an instrument mounting platform 207. Instrument mounting platform 207 may have one or more holes (e.g., holes 206a-b) and/or formed therein for facile mounting of the instrument 205 onto a (movable) surface or platform.

Viewing device 210 has an interface end (e.g., a light receiving end) and a viewing end (e.g., a light output or exit end). Viewing device 210 has a cavity between the interface end and viewing end for holding optics, such as mirrors, lenses, prisms, and/or an eyepiece. Viewing device 210 may have any shape capable of holding the optics and transmitting light from the interface end to the viewing end. In one embodiment, the housing and/or cavity has a substantially cylindrical shape. The overall shape of viewing device 210 can generally be the same as or different from the shape of the cavity. For example, viewing device 110 can be generally cylindrical, rectangular or oval. The body of viewing device 210 can comprise any material, or combination of materials, capable of housing optics. For example, viewing device 210 may comprise one or more tubes, plates, rings, wires, etc. of metal, plastic, ceramic, etc., or a combination thereof.

Referring to FIG. 2, opening 170 can have any shape that allows the optical measuring instrument 205 to receive the viewing device 110 as shown in FIG. 1, viewing device 210 as shown in FIG. 2, viewing device 570 as shown in FIG. 5, and/or viewing device 630-635 as shown in FIG. 6. In one embodiment, opening 170 is a cylindrical opening with smooth interior sides. A portion of the interface end of the viewing device having a complimentary or matching shape is inserted into opening 170. The portion of the viewing device placed into opening 170 may be any length, as long as the viewing system is still capable of allowing the user to view the object being measured by optical measuring instrument (e.g., 105 of FIG. 1 and/or 205 in FIG. 2).

In another embodiment, opening 170 may have a ring or collar 220 on the inside, configured to engage with a corresponding groove or notch on the barrel of the insertable portion of the viewing system. Further, ring or collar 220 may be any configuration for releasably detaching the viewing system (e.g., viewing device 110 as shown in FIG. 1, viewing device 210 as shown in FIG. 2, viewing device 570 as shown in FIG. 5, and/or viewing device 630-635 as shown in FIG. 6). For example, ring or collar 220 may be a continuous ring, a partial ring, and/or one or more protrusions from or on the inside of the opening 170. In a further embodiment, the ring or collar 220 may be on the barrel of the viewing device 200, and the groove or notch may be in the opening 170.

In another embodiment, a gasket may be on the interface end of the viewing device and/or on the inside of the opening of the optical measuring instrument. In one embodiment, the interface end, having a gasket, is configured to be insertable into the opening, having smooth sides, of the optical measuring instrument. In another embodiment, a viewing device having smooth sides on the interface end can be insertable into the opening of the optical measuring instrument fitted with the gasket. In a further embodiment, the smooth sides of the interface end of the viewing device and/or the opening of the optical measuring instrument can be lubricated and/or coated with a silicone and/or Teflon.

In yet another embodiment, the diameter of the interface end of the viewing device is less than the diameter of the opening of the optical measuring instrument. For example, the difference between the diameter of the interface end of the viewing device and the diameter of the opening of the optical measuring instrument to provide a snug fit for inserting and/or sliding the viewing device into the opening of the optical measuring instrument. In another embodiment, the difference between the dimensions of the interface end of the viewing device and the opening of the optical measuring instrument is from 0.001 mm to 2 mm, or from 0.001% to 5%, or any range of values therein.

An Exemplary Protective Device for an Optical Sys m with a Detachable Viewing Device

In another aspect, the present invention relates to an optical measurement kit comprising the present viewing device, the optical measuring instrument, and a first cap or plug configured to be removably or detachably connected to an opening of the optical measuring instrument and/or the interface end of the viewing device. The protective cap or plug can be used to prevent light, dust, water, and/or other contaminants from entering the viewing device and/or optical measuring instrument when the viewing device is removed from the optical measuring instrument. The protective cap or plug is removably attached to the interface end of the viewing system and/or inserted into opening in the optical measuring instrument. The protective cap or plug can be of almost any shape and material. For example, the cap or plug may comprise rubber, metal, plastic, cloth, or the like, or any combination thereof.

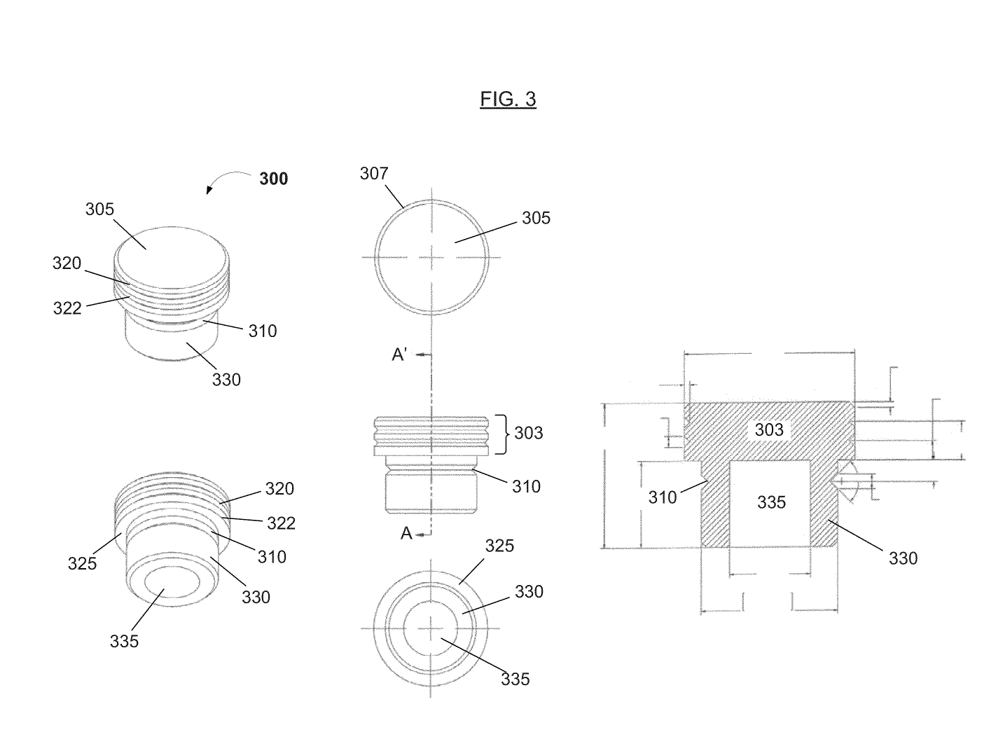

As is shown in FIG. 3, cap 300 has a top portion 303 that has a greater diameter than opening 170 in FIG. 1. For example, the top portion 303 of the cap 300 can have a diameter greater than the diameter of the opening in the measurement instrument of from 1 mm to 10 cm, or from 0.01% to 50%, or any value or range of values therein. In one embodiment, the top portion 303 of cap 300 has a diameter of or about 10-35 mm (e.g., about 23.5 mm). In a further embodiment, top portion 303 of cap 300 may have a beveled edge 307 around the topmost surface 305. A lower portion 330 of cap 300 is capable of being inserted into opening 170. In one embodiment, the lower portion 330 of cap 300 capable of being inserted into opening 170 has a diameter of or about 5-35 mm (e.g., about 18.8 mm) and a length of or about 5-25 mm (e.g., about 11.8 mm).

in another embodiment, cap 300 may have a space 335 (e.g., a gap, hollow, or opening) inside the lower portion 330. Space 335 may be configured to mate and/or receive a corresponding tube and/or housing portion of optical measuring instrument 105. In such an embodiment, space 335 may have the same diameter or a greater diameter than a corresponding tube and/or housing portion of optical measuring instrument 105. In one embodiment, space 335 has a diameter of or about 5-35 mm (e.g., about 11.2 mm) and a length of or about 5-25 mm (e.g., about 11.8 mm).

In another embodiment, cap 300 may have one or more grooves 310 on the lower portion 330. The groove(s) 310 may be configured to engage with a corresponding ring or collar 220 in the opening 170 of the optical measuring instrument (e.g., 105 in FIG. 1 and/or 205 in FIG. 2). Further, ring or collar 220 may have any configuration for releasably detaching cap 300. For example, ring or collar 220 may be continuous, partial, and/or a series of projections. In a further embodiment, the ring or collar (e.g., similar to ring or collar 220, but made of a material for the cap 300) may be on the cap 300, and the groove or notch may be in the sidewall of the opening 170.

Any mechanism for facilitating removal of the cap can be used in the present invention. In one embodiment, the cap may have multiple grooves, ring(s) and/or collar(s) on the upper portion 303 (e.g., 320 and 322). The grooves 320 and 322 may facilitate gripping the upper portion 303 of cap 300 with one's fingers. In another embodiment, cap 300 may have a gasket on lower portion 330 or on the underside 325 of top portion 303. For example, the gasket may be made of rubber, metal, cloth, felt, or any combination thereof.

Referring now to FIG. 4, the exemplary cap (or plug) 300 can be inserted into opening 170 to prevent light, dust, water or other contaminants from entering optical measuring instrument 105 when the viewing system (e.g., viewing device 110 as shown in FIG. 1, viewing device 210 as shown in FIG. 2, viewing device 570 as shown in FIG. 5, and/or viewing device 630-635 as shown in FIG. 6) is removed. The cap 300 may have any shape and/or size for preventing damage to and/or contamination from entering the optical measuring instrument (e.g., 105 in FIG. 1 or 205 in FIG. 2) via opening 170. In one embodiment, the cap fits over opening 170. In another embodiment, a portion (e.g., lower portion 330) of cap 300 is inserted into opening 170. In a further embodiment, space 335 fits over a corresponding tube and/or housing portion of the optical measuring instrument (e.g., 105 in FIG. 1 or 205 in FIG. 2).

An Exemplary Detachable and Rotatable Viewing Device

In a further aspect, the present invention relates to a detachable viewing device comprising one or more rotating joints. Viewing devices with one or more rotating joints, adapted for use with optical measuring instruments, are disclosed in co-pending and commonly-assigned U.S. patent application Ser. No. 13/801,428, filed Mar. 13, 2013 (Attorney Docket No. CRI-002), the relevant portions of which are incorporated herein by reference.

FIG. 5 illustrates an exemplary detachable viewing device 510 coupled to optical measuring instrument 105. Because viewing device 510 can rotate in a plane parallel to the optical axis 580 of optical measuring instrument 205 (e.g., a horizontal plane above the optical measuring instrument 205), it may be considered a “horizontal” viewing system.

Viewing device 510 has an interface end (e.g., a light receiving end) and a viewing end (e.g., a light output or exit end). Viewing device 510 has a cavity between the interface end and viewing end for holding optics, such as mirrors, lenses, prisms, and/or an eyepiece. Viewing device 510 may have any shape capable of holding the optics and transmitting light from the interface end to the viewing end. In one embodiment, the housing and/or cavity has a substantially cylindrical shape. The overall shape of viewing device 510 can generally be the same as or different from the shape of the cavity. For example, viewing device 510 can be generally cylindrical, rectangular or oval. Further, the body between the interface end and a viewing end of viewing device 510 is angled (or bent) in at least one location. In another embodiment, the body between the interface end and a viewing end of viewing device 510 has a bend with an angle of 90°. The body of viewing device 510 can comprise any material, or combination of materials, capable of housing optics. For example, viewing device 510 may comprise one or more tubes, plates, rings, wires, etc. of metal, plastic, ceramic, etc., or a combination thereof.

Rotating joint 560 allows viewing device 510 to rotate any number of degrees in a plane that is (i) parallel to the measurement axis 180 of optical measuring instrument 105 and (ii) perpendicular to the plane of the page. In one embodiment, the viewing device 510 may rotate 360° in this plane. The ability to rotate the viewing device 510 allows the viewer to view the object being measured from all sides of optical measuring instrument 205. Further, to facilitate positioning of the viewing device 510, the rotating joint 560 may have soft stops every 360°/n, where n is an integer of 2 or more (e.g., from 4 to 24, resulting in increments of 30°, 45°, or 90°, or other fixed value or angle between the rotational soft stops), relative to the optical axis 580. The soft stops may be in a fitting inside rotating joint 560. The soft stops may comprise one or more complementary notches and ridges or projections on opposed surfaces of rotating joint 560, or a notch-and-spring-loaded-bearing mechanism 218a-b and/or 262, etc. Pressure on bearing 118a can be adjusted through a spring between it and a screw or bolt in fitting/opening 165. Further, the projection 218b can also be similarly adjusted. Viewing device 510 further comprises angled mirror 540, one or more rotating joints (e.g., rotating joint 560), and eyepiece 150. In one embodiment, viewing device 510 can have an angle of 90°, such that a first section of viewing device 510 extends generally perpendicular to the optical axis 580 of optical measuring instrument 205, and a second section is generally parallel to the optical axis 580 of optical measuring instrument 205. Light from the object being measured and/or evaluated by the optical measuring instrument 205 reflects from angled mirror 240 to angled mirror 540, and then from angled mirror 540 to eyepiece 150 of viewing device 510. A viewer can thus look through the eyepiece 150 to view the object being measured by the optical measuring instrument 205.

Angled mirror 540 may be aligned with the optical axis of the light reflected from or by angled mirror 240. Angled mirror 540 is mounted or affixed at or near a bend in viewing device 510. In one embodiment, the angled mirror 540 may be mounted or attached on substrate 190 that serves as an exterior in the housing of viewing device 510, and the substrate 190 may be configured to fit in a space and/or opening in the housing of viewing device 510. Angled mirror 540 can be placed at any angle suitable to allow angled mirror 540 to be aligned with the optical axis of the light reflected off angled mirror 240 and eyepiece 150. In one embodiment, the angled mirror 540 is placed at or about a 45° angle to the optical axis 580 of the light reflected by angled mirror 240.

The eyepiece (or ocular lens) 150 can be any eyepiece that allows the viewer to view the object being measured by optical measuring instrument 205. Further, eyepiece 150 can comprise a barrel (e.g. 152 and one or more lenses 154 and/or groups of lenses. Eyepiece 150 may further comprise an eye lens 156. Eyepiece 150 may also comprise a cup 158 of any suitable shape and distance from the eye lens 156. In further embodiments, the eyepiece 150 may further comprise a diopter adjustment and/or aperture. In other embodiments, the eyepiece may have a diameter of 20 mm-30 mm. In still other embodiments, the one or more lenses may be concave, convex, and any combination thereof. In other embodiments, eyepiece 150 may comprise a mechanism for attaching a camera and/or computer display.

A Further Exemplary Detachable and Rotatable Viewing Device

Referring now to FIG. 6, another aspect of the present invention relates to a viewing device 630-636 that generally includes an angled mirror 540, a pentaprism 660, one or more rotating joints (e.g., rotating joint 670), and an eyepiece 150. In a further embodiment, viewing device 630-635 may have one or more lenses and/or groups of lenses (e.g., lens 650) between the angled mirror 540 and the pentaprism 660. Because viewing device 630-635 can rotate in a plane perpendicular to the optical axis of optical measuring instrument 105 (e.g., a vertical plane above the optical measuring instrument 105), it may be considered a “vertical” viewing system for use with the optical measuring instrument 105 (e.g., a colorimeter).

Viewing device 630-635 has an interface end, proximal to the optical measuring instrument 105, and a viewing end, distal to the optical measuring instrument 105. Viewing device 630-635 has a cavity between the interface end and viewing end for holding optics, such as mirrors, lenses, prisms, and/or an eyepiece. Viewing device 630-635 may have any shape capable of holding the optics and transmitting light from the interface end to the viewing end. In one embodiment, the housing and/or cavity has a substantially cylindrical shape. The overall shape of viewing device 630-635 can generally be the same as or different from the shape of the cavity. For example, viewing device 630-635 can be generally cylindrical, rectangular or oval. Further, the body between the interface end and a viewing end of viewing device 630-635 is angled (or bent) in at least one location. In one embodiment, the body between the interface end and a viewing end of viewing device 630-635 has a bend with an angle of 90°. The body of viewing device 630-635 can comprise any material, or combination of materials, capable of housing optics. For example, viewing device 630-635 may comprise one or more tubes, plates, rings, wires, etc. of metal, plastic, ceramic, etc., or a combination thereof.

In one embodiment, viewing device 630-635 comprises a first section 630, a second section 635 and a rotatable joint 670 between the first and second sections 630 and 635. The first section 630 of the body of viewing device 630-635 extends generally perpendicular to the optical axis 580 of optical measuring instrument 605. The second section 635 also extends generally perpendicular to the optical axis 580 of optical measuring instrument 605.

In one exemplary embodiment, angled mirror 540 is mounted or affixed in the first section 630, and a pentaprism 660 is mounted or affixed in the second section 635, Light from the object being measured and/or evaluated by the optical measuring instrument 605 reflects from angled mirror 640 towards the angled mirror 540, then from angled mirror 540 through an optional lens 650 into the pentaprism 660. The light continues from pentaprism 660 to the eyepiece 150 of the viewing device 630-635. A viewer can thus look through the eyepiece 150 to view the object being measured by the optical measuring instrument 605.

Angled mirror 540 may be aligned with the optical axis of the light reflected from and/or by angled mirror 640. Angled mirror 540 is mounted or affixed at or near where the first section 630 and the second section 635 meet in the body of viewing device 630-635. In one embodiment, the angled mirror 540 may be mounted or attached on substrate 690 that serves as an exterior in the first section 630 of viewing device 630-635, and the substrate 690 may be configured to fit in a space and/or opening in the upper section 630. In another embodiment, the viewing system comprises a third section (not shown) between the first section 630 and the second section 635, configured to separate the first and second sections 630 and 635 and/or facilitate a second (e.g., horizontal) degree of rotational freedom in the viewing apparatus 600. In a further embodiment, the third section may be substantially parallel to the measuring instrument. In further embodiments, the angled mirror 540 may be positioned at or about a location equidistance from pentaprism 660 and the interface end of the optical measuring instrument 605. Angled mirror 540 can be placed at any angle allowing angled mirror 540 to be aligned with the optical axis of the light reflected from angled mirror 640 (and optionally, from pentaprism 660). In one embodiment, the angled mirror 540 has a 45° angle with respect to the optical axis of light reflected by mirror 640.

In general, a pentaprism is a five-sided reflecting prism used to reflect a beam of light by a constant 90°. This reflection angle may result even if the entry beam is not at 90° to the face of the prism that it enters. In other embodiments, the pentaprism can be replaced with one or more mirrors. In further embodiments, the pentaprism can be replaced with a second mirror. Pentaprism 660 is mounted or affixed at or near a second bend in the body of viewing device 630-635. In one embodiment, the pentaprism 660 may be mounted or attached on substrate 665 that serves as an exterior in the second section 635 of viewing device 630-635, and the substrate 665 may be configured to fit in a space and/or opening in the second section 635. One face of pentaprism 660 is generally perpendicular to the optical axis of the light reflected from angled mirror 540, and a second face is generally perpendicular to the optical axis of eyepiece 150.

The eyepiece (or ocular lens) 150 can be any eyepiece that allows the viewer to view the object being measured by optical measuring instrument 605. Further, eyepiece 150 can comprise a barrel (e.g. 152 and one or more lenses 154 and/or groups of lenses. Eyepiece 150 may further comprise an eye lens 156. Eyepiece 150 may also comprise a cup 158 of any suitable shape and distance from the eye lens 156. In further embodiments, the eyepiece 150 may further comprise a diopter adjustment and/or aperture. In other embodiments, the eyepiece may have a diameter of 20 mm-30 mm. In still other embodiments, the one or more lenses may be concave, convex, and any combination thereof. In other embodiments, eyepiece 150 may comprise a mechanism for attaching a camera and/or computer display.

Rotating joint 670 allows for the upper section 635 of viewing device 630-635 to rotate a number of degrees in a plane that is perpendicular to the measuring instrument 610. In one embodiment, vertical viewing device 630-635 rotates up to about 270°. The ability to rotate upper section 635 of viewing device 630-635 allows the viewer to view the object being measured from different sides of optical measuring instrument 105. Further, the rotating joint 670 may have soft stops every 30°, 45° or 90° (or other fixed value or angle) relative to the optical axis 480 to facilitate positioning of viewing device 630-635. The soft stops may be located in a fitting inside 630. Further, the soft stops may comprise complementary notches 621a-b and ridges or projections 218a-b on opposing surfaces inside the rotatable joint 670, a similar notch-and-spring-loaded-bearing mechanism, etc. The observed image may rotate as viewing device 630-635 is rotated about rotating joint 670, but the image is not rotated or reversed when the image of the object being measured is observed with the eyepiece rotated +90° or −90° from the vertical position. In another embodiment, the lower section 635 of the vertical viewing device has a second rotating joint in the same location as rotating joint 560 in the exemplary viewing system of FIG. 5.

An Exemplary Shutter for a Viewing System

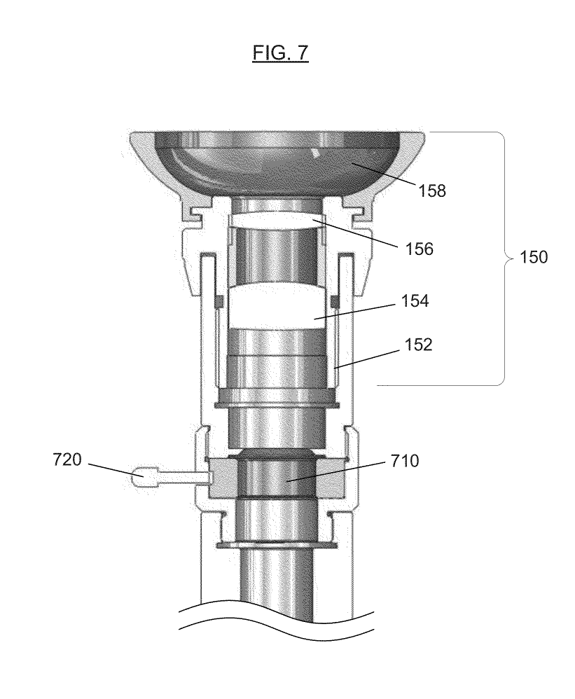

Referring now tot FIG. 7, another aspect of the present invention relates to a rotatable viewing device that generally includes a shutter 710. For example, the viewing device 110 as shown in FIG. 1, viewing device 210 as shown in FIG. 2, viewing device 570 as shown in FIG. 5, and/or viewing device 630-635 as shown in FIG. 6 may comprise a shutter 710. In one embodiment, shutter 710 may be permanently or detachably mounted or placed between the viewing end and either the interface end or a bend in the housing of the viewing device. For example, the shutter 710 may be permanently or detachably mounted or placed between the eyepiece 150 or the camera mount 160 (FIG. 1) and the interface end in the housing of the viewing device. In another embodiment, shutter 710 may be permanently or detachably mounted or placed between the pentaprism 560 and the eyepiece 150 in the upper section 535 of the rotatable viewing system of FIG. 5. Shutter 710 may comprise an aperture (i) capable of opening or closing, and/or (ii) configured to control the amount of light that passes through the viewing system to eyepiece 150. Shutter 710 may further comprise a lever, knob dial or switch 720 configured to control the extent to which the aperture or the shutter 710 opens or closes.

An Exemplary Method of Using an Optical Measuring Device

The present invention further relates to a method of using an optical measuring device. Specifically, the method of using an optical measuring device may comprise attaching a detachable viewing device to an optical measuring instrument, observing an object through the viewing device and the optical measuring instrument, and removing the viewing device from the optical measuring instrument (e.g., when not in use).

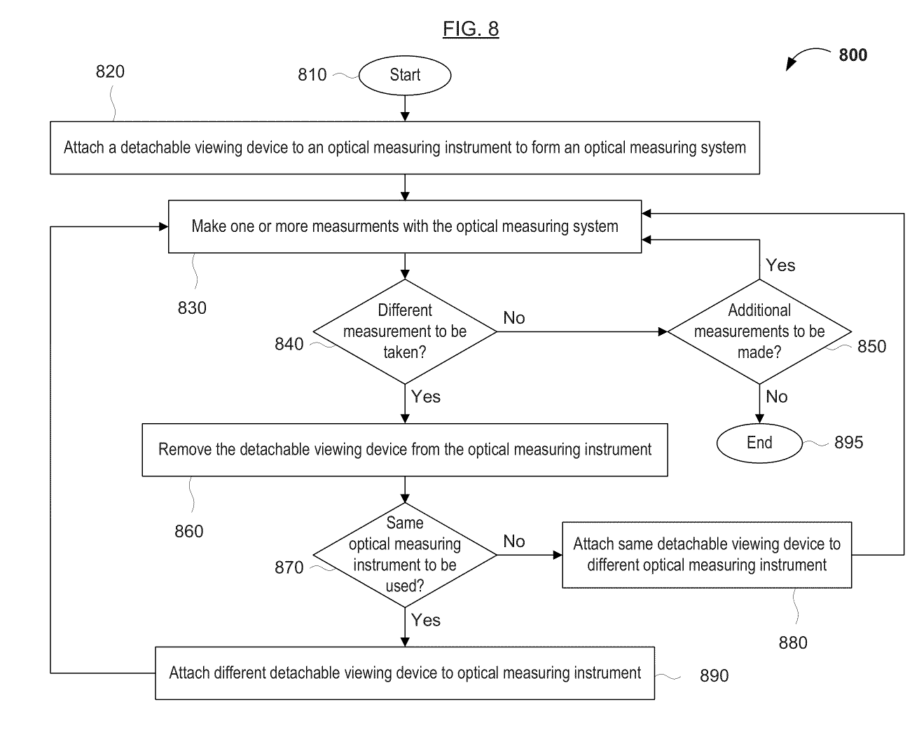

Flow chart 800 of FIG. 8 illustrates an exemplary method of using an optical measuring device according to the present invention. The method may begin at 810, and at 820, the method comprises attaching a detachable viewing device to an optical measuring instrument to form an optical measuring system. The viewing device may be any viewing device that allows a user to use the optical measuring instrument. For example, the viewing device may be the viewing device 110 as shown in FIG. 1, viewing device 210 as shown in FIG. 2, viewing device 570 as shown in FIG. 5, and/or viewing device 630-635 as shown in FIG. 6. The optical measurement instrument may comprise any instrument capable of taking optical measurements. In various embodiments, the optical measurement instrument may comprise a photometer, colorimeter, spectrophotometer, or spectroradiometer.

At 830, the method comprises making one or more measurements with the optical measuring system. Examples of optical measurements may include measurements relating to color matching and/or calibration, colorimetry, spectrophotometry, etc. In various embodiments, the optical measuring system may take optical measurements (e.g., photometry, colorimetry, spectrophotometry, optical spectroscopy, or spectroradiometry) of various objects. Examples of specific objects may include manufactured objects that may have one or more labels, inks, or attachments thereon, chemical or material samples (which may be in the solid, liquid and/or gas phase[s], environmental samples (e.g., water and/or soil), medical samples (e.g., blood), textiles, precious stones, LCD, CRT, or LED displays, etc.

In other embodiments, operation of the detachable viewing device may include rotating the detachable viewing device to a desired position, thereby enabling the user to view the object, and optionally, facilitating alignment of the optical measuring instrument with the object. For example, the user may rotate the viewing device to any position that is accessible, convenient, comfortable and/or desirable for the user. For example, viewing device 410 (FIG. 4) and/or viewing device 630-635 (FIG. 5) may be rotated one or more of a plurality of predetermined numbers of degrees in a plane parallel, orthogonal and/or vertical to the optical measuring instrument (e.g., 105 in FIG. 1 and/or 205 in FIG. 2).

At 840, the method comprises determining whether different measurements are to be taken. Alternatively, at 840, the method comprises determining whether different view(s) are to be made. For example, a different measurement may be taken when the first measurement(s) determine the wavelength and intensity of visible radiation reflected by an object, but another type of measurement is desired, such as measurements of the ultraviolet or infrared light absorption of the object. If different measurements are to be taken, the flow continues to 860; otherwise, the flow continues to 850. At 850, if additional measurements or views are not to be made, then the flow ends at 895. If at 850 the viewer desires to take additional measurements or make additional views (e.g., using the same viewing device), then the flow returns to 830.

At 860, the method may comprise removing the viewing device from the optical measuring instrument. In a further embodiment, the method may comprise placing one or more caps or plugs on or in (i) the end of the viewing device that interfaces with the optical measuring instrument and/or (ii) an opening in the optical measuring instrument where the viewing device in inserted. For example, referring to FIG. 4, the cap 300 may be placed in the opening 170 of the optical measuring instrument 105.

At 870, one determines whether to use the same optical measuring instrument to take the different measurements. If the same optical measuring instrument is to be used, then the method continues to 890. At 890, a different viewing device may be attached to the same optical measuring instrument. For example, a viewer may want to use a different viewing device having different mechanical and/or optical characteristics (e.g., the viewing device 700 in FIG. 7 having a shutter), that may be easier to use and position (e.g., the horizontally rotatable viewing device 500 in FIG. 5 and/or vertically rotatable viewing device 600 in FIG. 4), or that has a different viewing mechanism (e.g., a viewing device 100 in FIG. 1 having a camera 160 or the viewing device 210 in FIG. 2 having an eyepiece 150) The flow then continues at 830.

If, at 870, a different optical measuring instrument is to be used, then the flow continues to 880. For example, if a colorimeter was used and now measurements of the radiance (e.g., intensity), reflectance, and/or absorbance of light are needed, the detachable viewing device may be removed from the colorimeter and attached to a different optical measuring instrument (e.g., a spectroradiometer). At 880, the method attaches the same detachable viewing device to a different optical measuring instrument. The flow then continues at 830.

Thus, by utilizing one or more detachable viewing devices, the present method is capable of efficiently using multiple viewing devices on multiple optical measuring instruments to take a variety of measurements. Alternatively, the present method provides for using one viewing device on many measuring instruments. In another alternative, the present method provides for using multiple viewing devices with one measuring instrument. Additionally, the present method avoids the issues and/or problems associated with redundant viewing devices.

An Exemplary Method of Making a Detachable Viewing Device

The present invention further relates to method of making a detachable viewing device. Specifically, the method of making a detachable viewing device may comprise forming a housing having an interface end opposite a viewing end, permanently or detachably connecting an eyepiece to the viewing end of the housing, and forming an attachment mechanism at or near the interface end of the housing configured to releasably or detachably connect to an optical measuring instrument. In one embodiment, the mirror and eyepiece comprise pre-assembled components.

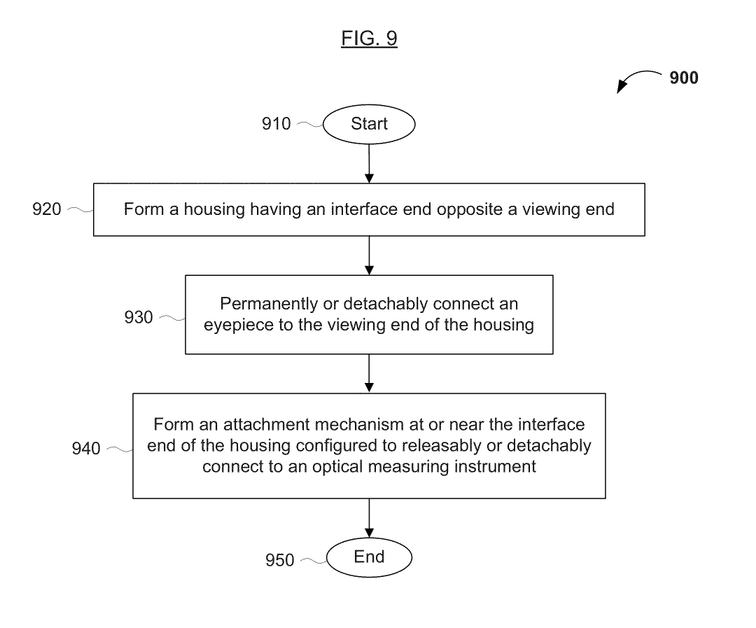

Flow chart 900 of FIG. 9 illustrates a method of making a detachable viewing device according to the present invention. The method encompasses forming a housing having an interface end opposite a viewing end, permanently or detachably connecting an eyepiece to the viewing end of the housing, and forming an attachment mechanism at or near the interface end of the housing configured to releasably or detachably connect to an optical measuring instrument.

The method may begin at 910, and at 920, the method comprises forming a housing. In further embodiments, the housing may comprise one or more sections, rotatable joints and/or connections. The one or more sections, rotatable joints and/or connections may be connected using adhesives, welds, grooves and O-rings, screws, rivets, combinations thereof, etc. in still further embodiments, various parts of the housing may have complementary screw-type threads and grooves configured to connect to one or more other parts of the housing. In other embodiments, there may be one or more openings in the housing, in one or more sections and/or at one or more intersections of the one or more sections. In further embodiments, the opening(s) are configured to receive a housing piece on or in which the mirror and/or pentaprism have been affixed or mounted. Thus, the mirror(s) and/or pentaprism may be mounted or affixed onto a substrate configured to mate with or fit over and/or into the opening in the housing an adhesive, welds, a groove and O-ring fitting, screws, rivets, snap-on fittings, combinations thereof, etc.

In one embodiment, the housing is formed with a cavity having a cylindrical, rectangular or oval shape. In another embodiment, the housing may have one or more bend(s) having an angle of about 90°. In other or further embodiments, the housing includes one or more tubes, plates, rings, wires, etc. of metal, plastic, ceramic, etc., or a combination thereof. In yet other or further embodiments, the housing limits the amount of outside (e.g., external or extraneous) light that enters the viewing device, or substantially completely prevents external light from entering the viewing device.

At 930, an eyepiece (which may be pre-assembled) is permanently or detachably connected to the viewing end of the viewing housing. The eyepiece may comprise a barrel, one or more adjustable and/or focusing lenses, an eye lens, and/or a cup. In further embodiments, the eyepiece may further comprise a diopter adjustment and/or aperture. The eyepiece may have a diameter of 20 mm-30 mm. The lens(es) may be concave, convex, or any combination thereof. In some embodiments, the eyepiece may be detachably connected to the housing a quick release mechanism, a groove and O-ring mechanism, a notch-and-bearing mechanism, complementary thread(s) and groove(s) on the housing and eyepiece, and/or a slidable (e.g., tongue-and-groove) connection to the housing. In another embodiment, the eyepiece may comprise a mechanism for attaching a camera and/or computer display. In another embodiment, the eyepiece may be formed inside the housing. For example, one or more lenses, an eye lens, and/or a cup may be permanently connected inside and/or to the housing.

At 940, an attachment mechanism is formed at or near the interface end of the housing configured to releasably or detachably connect to an optical measuring instrument, in further embodiments, formation of the attachment mechanism comprises forming a ring, collar, notch, or groove at or near the interface end of the housing. In one embodiment, formation of the attachment mechanism comprises forming a ring or collar that can be a continuous ring, a partial ring, and/or one or more protrusions from or on the interface end of the housing. In a further embodiment, formation of the ring or collar may comprise forming a plurality of ball bearings in a semicircular groove from or on the interface end of the housing. In further embodiments, the attachment mechanism can be configured to detachable or removably connect with a corresponding ring, collar, notch, or groove in the optical measuring instrument.

In another embodiment, formation of the attachment mechanism comprises forming smooth sides configured to be insertable and/or slidable into the opening of the optical measuring instrument. In another embodiment, formation of the attachment mechanism comprises forming the diameter of the interface end of the housing to be smaller than the opening of the optical measuring instrument. In a further embodiment, formation of the attachment mechanism can include lubricating and or coating the attachment mechanism with silicone and/or Teflon. In yet another embodiment, formation of the attachment mechanism may comprise permanently or removably attaching a gasket on the interface end of the viewing device.

It will be readily understood by those skilled in the art that the components of the detachable viewing device are aligned to allow light entering an interface end of the housing to exit at a viewing end of the housing. For example, the location and/or angle of the mirror inside the housing may be any location and/or angle that ensure good viewing characteristics of an object when viewed through the eyepiece. In another example, the length and/or diameter of the one or more sections of the housing may vary depending on the viewing characteristics of the eyepiece (e.g., the focal length and/or diameter of the eyepiece) and vice versa. In various embodiments, alignment of the optical components of the rotatable viewing device may generally involve aligning the components with each other (e.g., an adjacent optical component) during assembly of the rotatable viewing device, and then having a final alignment of all components once all of the optical components have been mounted or affixed within the housing. At 950, the method ends.

### CONCLUSION/SUMMARY

Thus, the present invention provides for a detachable viewing device that is removeably and/or detachably connectable to an optical measuring instrument. Alternatively, the present invention may also concern a viewing device having an opening and an optical measuring instrument having an interface with an attachment mechanism for detachably and/or reversibly connecting the viewing device. The present invention reduces problems associated with conventional viewing systems and therefore enjoys particular advantages in use with measuring instruments (e.g., optical measuring instruments) such as having one viewing device for multiple measuring instruments or multiple viewing devices for use with a single instrument; reducing the weight of the instrument when not in use (e.g., when being moved); and protecting the viewing device when not in use. The present invention also concerns methods for manufacturing and using a viewing system according to the present invention.

The foregoing descriptions of specific embodiments of the present invention have been presented for purposes of illustration and description. They are not intended to be exhaustive or to limit the invention to the precise forms disclosed, and obviously many modifications and variations are possible in light of the above teaching. The embodiments were chosen and described in order to best explain the principles of the invention and its practical application, to thereby enable others skilled in the art to best utilize the invention and various embodiments with various modifications as are suited to the particular use contemplated.

What is claimed is:

1. A viewing device, comprising:
a. a housing, having an interface end opposite a viewing end;
b. an eyepiece, having one or more lenses, and located at or near the viewing end; and
c. an attachment mechanism configured to releasably or detachably connect the viewing device to an optical measuring instrument.

2. The viewing device of claim 1, wherein the attachment mechanism comprises one of (i) a ring or collar or (ii) a corresponding groove or notch, configured to engage with a complementary (i) groove or notch or (ii) ring or collar in the opening of the optical measuring instrument.

3. The viewing device of claim 1, wherein the attachment mechanism comprises one or more substantially longitudinal grooves or notches at or near the interface end of the viewing device, configured to engage with a corresponding longitudinal protrusion(s) in the opening of the optical measuring instrument.

4. The viewing device of claim 1, wherein the viewing device further comprises an adapter at or near the viewing end, the adapter configured to attach an image capture and/or image display device.

5. The viewing device of claim 5, wherein the adapter comprises a camera mount or a connection to a monitor and/or computer display.

6. The viewing device of claim 1, wherein the viewing device is substantially straight and perpendicular to the optical measuring instrument.

7. The viewing device of claim 1, wherein the housing has one or more bends between the interface end and the viewing end and at least one mirror mounted or affixed at or near one of the one or more bends.

8. The viewing device of claim 1, further comprising one or more extensions between the interface end and the eyepiece.

9. The viewing device of claim 1, further comprising a shutter configured between the interface end and the eyepiece.

10. The viewing device of claim 1, further comprising one or more rotatable joints or connections allowing at least part of the viewing device to be rotated.

11. The viewing device of claim 10, wherein the one or more rotatable joints or connections allow at least part of the viewing device to be horizontally rotated.

12. The viewing device of claim 10, wherein the one or more rotatable joints or connections allow at least part of the viewing device to be vertically rotated.

13. An optical measurement kit, comprising:
a. the viewing device of claim 1;
b. the optical measuring instrument; and
c. a first cap or plug configured to be removeably or detachably connected to an opening of the optical measuring instrument and/or the interface end of the viewing device.

14. The optical measurement kit of claim 13, further comprising a second cap or plug removeably or detachably connected to the interface end of the viewing device.

15. A method of viewing an object, comprising:
a. attaching the viewing device of claim 1 to an optical measuring instrument;
b. observing an object through the viewing device and the optical measuring instrument; and
c. removing the viewing device from the optical measuring instrument.

16. The method of claim 15, further comprising taking one or more measurements with the optical measuring instrument.

17. A method of making a viewing device, comprising:
a. forming a housing having an interface end opposite a viewing end;
b. permanently or detachably connecting an eyepiece to the viewing end of the housing; and
c. forming an attachment mechanism at or near the interface end of the housing configured to releasably or detachably connect to an optical measuring instrument.

18. The method of claim 17, wherein forming the attachment mechanism comprises forming a ring, collar, notch, or groove at or near the interface end of the housing configured to connect with a corresponding ring, collar, notch, or groove in the optical measuring instrument.

19. The method of claim 17, wherein forming the housing comprises a section and/or a combination of one or more sections to form one or more bends in the housing.

20. The method of claim 17, wherein forming the housing comprises one or more rotatable joints or connections.
